(19) United States
(12) Patent Application Publication
(10) Pub. No.: US 2015/0352699 A1
(43) Pub. Date: Dec. 10, 2015

(54) Power Tool

(71) Applicant: Hitachi Koki Co., Ltd., Tokyo (JP)

(72) Inventors: Hironori SAKAI, Hitachinaka, Ibaraki (JP); Naoki TADOKORO, Hitachinaka, Ibaraki (JP)

(21) Appl. No.: 14/760,520

(22) PCT Filed: Jan. 15, 2014
(86) PCT No.: PCT/JP2014/000166

§ 371 Date: Jul. 13, 2015

(30) Foreign Application Priority Data
Jan. 24, 2013 (JP) 2013-011094
Jan. 24, 2013 (JP) 2013-011095

(51) Int. Cl. B25B 21/02

(52) U.S. Cl. CPC B25B 21/026

(57) ABSTRACT

A power tool includes a housing, a motor, a hammer, an anvil, and a controller. The motor is accommodated in the housing. The hammer is configured to be rotated by the motor. The anvil is configured to be rotated in one of a rotational mode in which the anvil is rotated together with the hammer and a striking mode in which the anvil is rotated upon being struck by the hammer. The controller is configured to control the motor to be braked in the striking mode.

### TECHNICAL FIELD

The invention relates to a power tool, and more particularly to a power tool that outputs rotational driving force.

### BACKGROUND ART

An impact wrench which is an example of a conventional power tool includes a motor, a spindle rotated by the motor, a hammer rotated by the spindle, and an anvil struck by the hammer. The anvil is provided with a detachable end bit, and a fastener such as a bolt is fastened to a workpiece by the end bit (For example, disclosed in Japanese Patent Application Publication No. 2009-72888).

### DISCLOSURE OF INVENTION

### Solution to Problem

However, in a fastening operation to a hard workpiece, because large reaction force is generated to the hammer upon striking the anvil, the hammer excessively moves back and impacts the spindle (cam-end collision). This impact causes the hammer and the spindle to be temporarily locked with each other, and thus striking timings between the hammer and the anvil is deviated from normal striking timings therebetween. Thus, the striking force of the hammer is not transmitted sufficiently to the anvil, which causes a striking malfunction. Once such a striking malfunction occurs, the striking malfunction occurs successively, which causes a drop in fastening force of the impact wrench, vibrations, an increase in noise, and the like.

The power tool changes control of the motor after the cam-end collision occurs by detecting the collision to prevent striking failures from occurring repeatedly. However, such a power tool cannot prevent the occurrence of the cam-end collision itself. Therefore, a further improvement is desired. In view of the foregoing, it is an object of the invention to provide a power tool capable of preventing the occurrence of the striking malfunction.

In order to attain the above and other objects, the present invention provides a power tool. The power tool includes a housing, a motor, a hammer, an anvil, and a controller. The motor is accommodated in the housing. The hammer is configured to be rotated by the motor. The anvil is configured to be rotated in one of a rotational mode in which the anvil is rotated together with the hammer and a striking mode in which the anvil is rotated upon being struck by the hammer. The controller is configured to control the motor to be braked in the striking mode.

It is preferable that the power tool further includes a power supply unit configured to supply drive power to the motor, and the controller is configured to control the power supply unit to temporarily set a duty ratio of the drive power to zero in the striking mode.

It is preferable that the controller is configured to control the motor to rotate in reverse in the striking mode.

It is preferable that the hammer is configured to be movable between a strike position where the hammer strikes the anvil and a remote position where the hammer is separated from the anvil in an axial direction of the motor, and the controller is configured to control the motor to be braked after the hammer strikes the anvil and before the hammer reaches the remote position.

According to another aspect, the present invention provides a power tool. The power tool includes a housing, a motor, a power supply unit, a hammer, an anvil, a load detection unit, and a controller. The motor is accommodated in the housing. The power supply unit is configured to supply drive power to the motor. The hammer is configured to be rotated by the motor. The anvil is configured to be rotated upon being struck by the hammer. The load detection unit is configured to detect a load of the motor. The controller is configured to control the power supply unit to decrease a duty ratio of the drive power supplied to the motor after the load begins to increase and before the load turns to decrease.

It is preferable that the load detection unit is configured to detect a fastening torque of the anvil, and the controller controls the power supply unit to decrease the duty ratio of the drive power after the fastening torque reaches a peak upon the striking of the hammer to the anvil.

It is preferable that the motor has an output shaft extending an axial direction, the hammer is configured to be movable between a strike position where the hammer strikes the anvil and a remote position where the hammer is separated from the anvil in the axial direction, and the controller controls the power supply unit to decrease the duty ratio of the drive power after the fastening torque reaches the peak and before the hammer reaches the remote position.

It is preferable that the load detection unit is configured to detect a current of the motor, and the controller controls the power supply unit to decrease the duty ratio of the drive power after the current of the motor turns from a decrease to an increase.

It is preferable that the controller controls the power supply unit to decrease the duty ratio of the drive power after the current of the motor turns from a decrease to an increase and before the current of the motor begins to decrease.

It is preferable that the load detection unit is configured to detect a rotational speed of the motor, and the controller controls the power supply unit to decrease the duty ratio of the drive power after the rotational speed turns from an increase to a decrease.

It is preferable that the controller controls the power supply unit to decrease the duty ratio of the drive power after the rotational speed turns from the increase to the decrease and before the rotational speed turns from the decrease to the increase.

According to another aspect, the present invention provides a power tool. The power tool includes a housing, a motor, a power supply unit, a hammer, an anvil, a load detection unit, and a controller. The motor is accommodated in the housing. The power supply unit is configured to supply drive power to the motor. The hammer is configured to be rotated by the motor. The anvil is configured to be rotated upon being struck by the hammer. The load detection unit is configured to detect a load of the motor. The controller is configured to control the power supply unit to change to a low duty mode in which a duty ratio of the drive power supplied to the motor decreases when a rate of change of the load of the motor exceeds a predetermined threshold value.

It is preferable that the load detection unit is configured to detect a fastening torque of the anvil, and the controller controls the power supply unit to change to the low duty mode when a rate of change of the fastening torque exceeds a torque threshold value.

It is preferable that the load detection unit is configured to detect a current of the motor, and the controller controls the power supply unit to change to the low duty mode when a rate of change of the current exceeds a current threshold value.

It is preferable that the load detection unit is configured to detect a rotational speed of the motor, and the controller controls the power supply unit to change to the low duty mode when a rate of change of the rotational speed exceeds a rotational speed threshold value.

According to another aspect, the present invention provides a power tool. The power tool includes a housing, a motor, a power supply unit, a hammer, an anvil, and a controller. The motor is accommodated in the housing. The power supply unit is configured to supply drive power to the motor. The hammer is configured to be rotated by the motor. The anvil is configured to be rotated upon being struck by the hammer. The controller is configured to control the power supply unit to change, based on a behavior of the hammer during a period from a striking between the hammer and the anvil to a subsequent striking therebetween, to a low duty mode in which a duty ratio of the drive power supplied to the motor decreases.

It is preferable that the power tool further includes a load detection unit configured to detect a current of the motor, and the controller controls the power supply unit to change to the low duty mode when the period exceeds a cycle threshold value.

It is preferable that the controller controls the power supply unit to change to the low duty mode when an integral of current from the striking to the subsequent striking exceeds an integral threshold value.

According to another aspect, the present invention provides a power tool. The power tool includes a housing, a motor, a power supply unit, a hammer, an anvil, a vibration detection unit, and a controller. The motor is accommodated in the housing. The power supply unit is configured to supply drive power to the motor. The hammer is configured to be rotated by the motor. The anvil is configured to be rotated upon being struck by the hammer. The vibration detection unit is configured to detect a vibration generated upon a striking between the hammer and the anvil. The controller is configured to control the power supply unit to decrease a duty ratio of the drive power supplied to the motor when the vibration detected by the vibration detection unit exceeds a vibration threshold value.

According to another aspect, the present invention provides a power tool. The power tool includes a housing, a motor, a power supply unit, a spindle, an engaging member, a hammer, an urging member an anvil, and a controller. The motor is accommodated in the housing and has an output shaft. The power supply unit is configured to supply drive power to the motor. The spindle is configured to be rotated by the motor and formed with a first groove extending in a direction intersecting an axial direction of the output shaft. The first groove has one end portion at the motor side and another end portion opposed to the one end portion in the axial direction. The engaging member has an accommodated part accommodated in the first groove and a remaining part. The hammer is configured to be supplied with a rotation from the spindle through the engaging member. The hammer is configured to be movable in the axial direction and formed with a second groove for accommodating the remaining part of the engaging member. The urging member is configured to urge the hammer in the axial direction. The anvil is configured to be rotated upon being struck by the hammer. The controller is configured to control the power supply unit to decrease a duty ratio of the drive power supplied to the motor before a cam-end collision occurs in which the engaging member contacts the one end portion of the first groove.

### Advantageous Effects of Invention

The invention can provide a power tool capable of preventing the occurrence of the striking malfunction.

### BRIEF DESCRIPTION OF DRAWINGS

FIG. 1 is a side cross-sectional view showing an overall structure of an impact wrench according to a first embodiment of the invention.

FIG. 2 is an exploded perspective view showing an impact mechanism of the impact wrench according to the first embodiment of the invention.

FIG. 3 is a perspective view showing the impact mechanism according to the first embodiment of the invention.

FIGS. 4A-4F are explanation views showing the operation of the impact mechanism according to the first embodiment of the invention.

FIG. 5 is a block diagram showing a motor of the impact wrench according to the first embodiment of the invention.

FIG. 6A is a graph having an ordinate representing rate of change of a current and an abscissa representing a time, FIG. 6B is a graph having an ordinate representing the current and an abscissa representing a time, FIG. 6C is a graph having an ordinate representing PWM duty ratio and an abscissa representing a time, FIG. 6D is a graph having an ordinate representing a rotational speed and an abscissa representing a time, FIG. 6E is a graph having an ordinate representing a torque and an abscissa representing a time, and FIG. 6F is a graph having an ordinate representing an acceleration and an abscissa representing a time.

FIG. 7 is a flowchart showing an operation of the impact wrench according to the first embodiment of the invention.

FIG. 8 is a flowchart showing an operation of an impact wrench according to a fourth and fifth modification of the first embodiment of the invention.

FIG. 9A is a graph having an ordinate representing rate of change of a current and an abscissa representing a time, FIG. 9B is a graph having an ordinate representing a current and an abscissa representing a time, FIG. 9C is a graph having an ordinate representing PWM duty ratio and an abscissa representing a time, FIG. 9D is a graph having an ordinate representing a rotational speed and an abscissa representing a time, FIG. 9E is a graph having an ordinate representing a torque and an abscissa representing a time, and FIG. 9F is a graph having an ordinate representing an acceleration and an abscissa representing a time.

FIG. 10 is a flowchart showing an operation of the impact wrench according to the second embodiment of the invention.

### BEST MODE FOR CARRYING OUT THE INVENTION

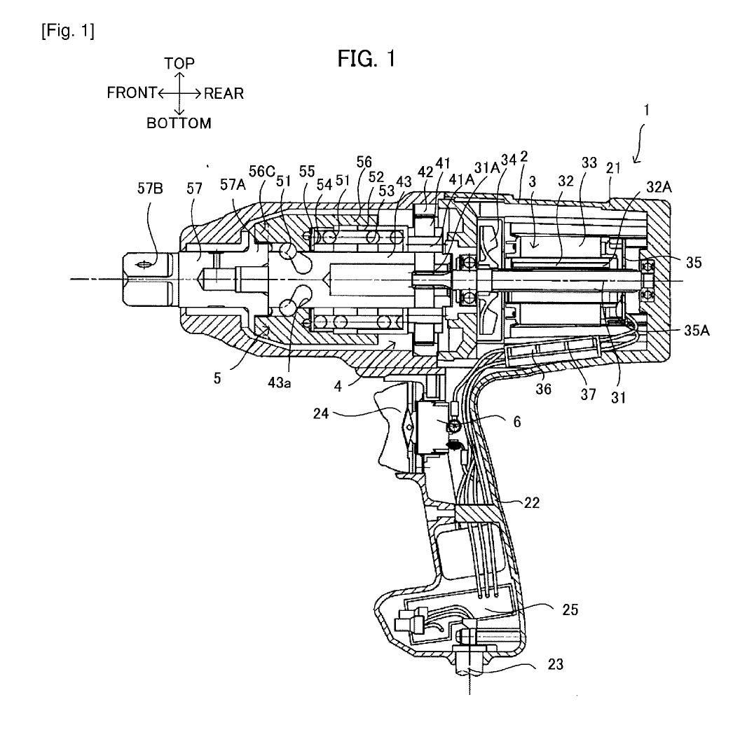

Hereinafter, an impact wrench 1 as an example of a power tool according to an embodiment of the invention will be described while referring to FIGS. 1 through 7. The impact wrench 1 shown in FIG. 1 mainly includes a housing 2, a motor 3, a gear mechanism 4, and an impact mechanism 5. The housing 2 is made of resin, and constitutes the outer shell of the impact wrench 1. The housing 2 mainly has a substantially hollow-cylindrical body portion 21 and a handle portion 22 extending from the body portion 21.

As shown in FIG. 1, the motor 3 is disposed within the body portion 21 such that the axial direction of the motor 3 is coincident with the longitudinal direction of the body portion 21. Also, within the body portion 21, the gear mechanism 4 and the impact mechanism 5 are arranged toward one end side in the axial direction of the motor 3. In the following description, a direction from the motor 3 toward the gear mechanism 4 and the impact mechanism 5 is defined as a front side. A direction parallel to the axial direction of the motor 3 is defined as a front-rear direction. Further, an upper-lower direction is defined such that a lower side is a side in which the handle portion 22 extends from the body portion 21. Left and right sides as viewed from the rear side of the impact wrench 1 are defined as left and right sides.

The body portion 21 is formed with air inlet ports (not shown) for introducing external air into the body portion 21, and is formed with air outlet ports (not shown) for discharging air in the body portion 21 to the outside with a fan 34 described later.

The handle portion 22 extends downward from a substantially center position of the body portion 21 in the front-rear direction, and is formed integrally with the body portion 21. The handle portion 22 is provided with a switch mechanism 6 configured to selectively switch a power supply to the motor 3. Also, the handle portion 22 has a bottom end portion provided with a power cable 23 connectable to a commercial power source (not shown) and extending therefrom in the extending direction of the handle portion 22. The handle position 22 extends from the body portion 21 at a root position provided with a trigger 24 manipulated by an operator. The root portion is at the front side of the handle portion 22. The handle portion 22 has a lower portion accommodating a rectifier circuit 25 for converting an AC current supplied from the power cable 23 into a DC current.

As shown in FIG. 1, the motor 3 is a brushless motor mainly including: a rotor 32 having an output shaft 31 and a permanent magnet 32A; and a stator 33 disposed at a position in confrontation with the rotor 32. The motor 3 is disposed within the body portion 21 such that the axial direction of the output shaft 31 matches the front-rear direction. The output shaft 31 protrudes forward and rearward of the rotor 32, and is rotatably supported by the body portion 21 via bearings at the protruding portions. The fan 34 is provided at a position at which the output shaft 31 protrudes forward. The fan 34 is rotatable coaxially and integrally with the output shaft 31. The output shaft 31 has a front end portion provided with a pinion gear 31A rotating coaxially and integrally with the output shaft 31.

A board 35 having a plurality of Hall elements 35A is disposed at the rear side of the motor 3. The plurality of Hall elements 35A is provided at positions confronting the permanent magnet 32A in the front-rear direction. For example, three Hall elements 35A are provided at a predetermined interval such as 60 degrees in the circumferential direction of the output shaft 31.

A control circuit 37 having a triaxial acceleration sensor 36 is provided at a position radially outward of the motor 3. The triaxial acceleration sensor 36 is adapted to detect accelerations in X, Y, Z-axis directions. In the present embodiment, acceleration in a thrust direction (axial direction) of the output shaft 31 is detected as acceleration in the Z-axis direction, and acceleration in a rotational direction (circumferential direction) of the output shaft 31 is detected as acceleration in the X, Y-axis directions. This enables detection of a shock of an impact operation by the impact mechanism 5 not only in the thrust direction but also in the rotational direction. The control circuit 37 is electrically connected to the board 35 and the rectifier circuit 25 via wiring. Detailed controls of the motor 3 will be described later. The triaxial acceleration sensor 36 is provided at a position adjacent to the motor 3 and on an imaginary extended line of the impact mechanism 5 in the axial direction, i.e., the triaxial acceleration sensor 36 is located at a position overlapped with the impact mechanism 5 as viewed from the axial direction. Hence, the triaxial acceleration sensor 36 can accurately detect a shock generated at the impact mechanism 5.

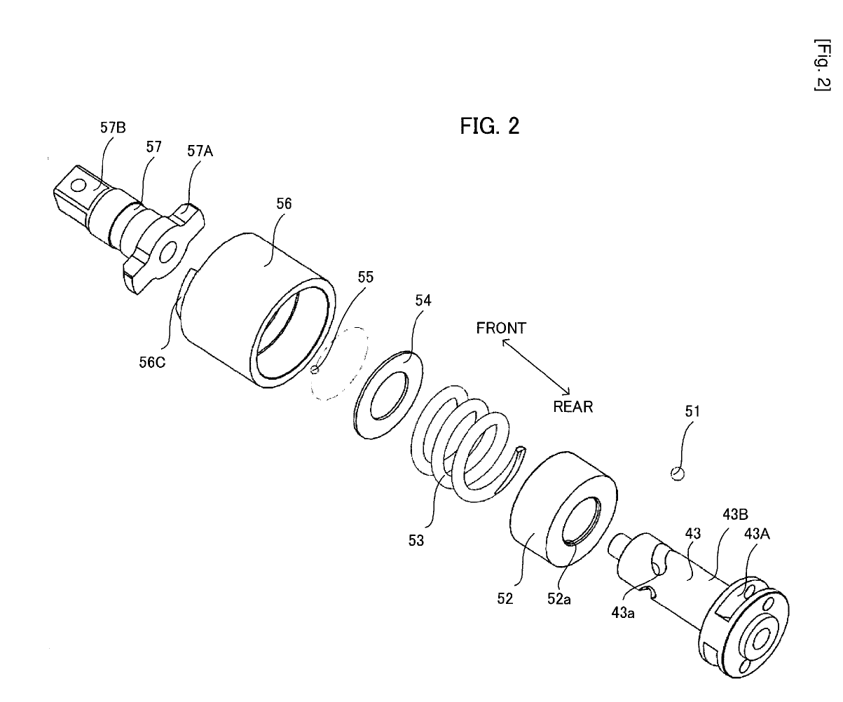

The gear mechanism 4 includes a pair of planetary gears 41 in meshing engagement with the pinion gear 31A, an outer gear 42 in meshing engagement with the planetary gears 41, and a spindle 43 for holding the planetary gears 41. The planetary gears 41 constitute a planetary gear mechanism having the pinion gear 31A as a sun gear. The planetary gears 41 decelerate rotations of the pinion gear 31A and transmit the decelerated rotations to the spindle 43. Each planetary gear 41 includes a rotational shaft 41A extending in the front-rear direction. The rotational shaft 41A is rotatably supported on the spindle 43. As shown in FIG. 2, the spindle 43 includes a gear supporting section 43A for supporting the planetary gears 41 and a shaft section 43B extending from the gear supporting section 43A. When the planetary gears 41 orbits the pinion gear 31A, the rotation causes the spindle 43 to rotate. In the following descriptions, an axial direction, a rotational direction, and a radial direction are directions with respect to the output shaft 31.

The shaft section 43B extends in the front-rear direction. The shaft section 43B is formed with two substantially V-shaped grooves 43a opposing each other with respect to the rotational axis of the shaft section 43B. Each groove 43a is formed such that the opening of the V shape is oriented rearward. Each groove 43a receives a ball 51 described later such that the ball 51 is movable along the corresponding groove 43a. The substantially V-shaped groove 43a is formed by combining two sides extending in diagonally downward directions such that, when the spindle 43 is in a normal rotation, the ball 51 reciprocates only in one side and that, when the spindle 43 is in a reverse rotation, the ball 51 reciprocates only in the other side. The groove 43a corresponds to a first groove portion of the present invention. The ball 51 corresponds to an engaging member of the present invention.

The impact mechanism 5 includes the ball 51, a stopper 52, a spring 53, a washer 54, a sphere 55, a hammer 56, and an anvil 57. The stopper 52 has substantially a hollow cylindrical shape. The stopper 52 is formed with a hole 52a penetrating the stopper 52 in the front-rear direction and through which the shaft section 43B is inserted. The stopper 52A has a front end surface contactable with the hammer 56 so as to prevent the hammer 56 from moving rearward more than a predetermined amount.

The spring 53 is a coil spring, and is fitted to the outside of the shaft section 43B. The spring 53 has a rear end portion in contact with the stopper 52, and a front end portion in contact with the washer 54. Thus, the spring 53 urges the hammer 56 in the forward direction via the washer 54. The washer 54 has substantially a disc shape, and is provided between the hammer 56 and the spring 53. The sphere 55 is provided between the washer 54 and the hammer 56.

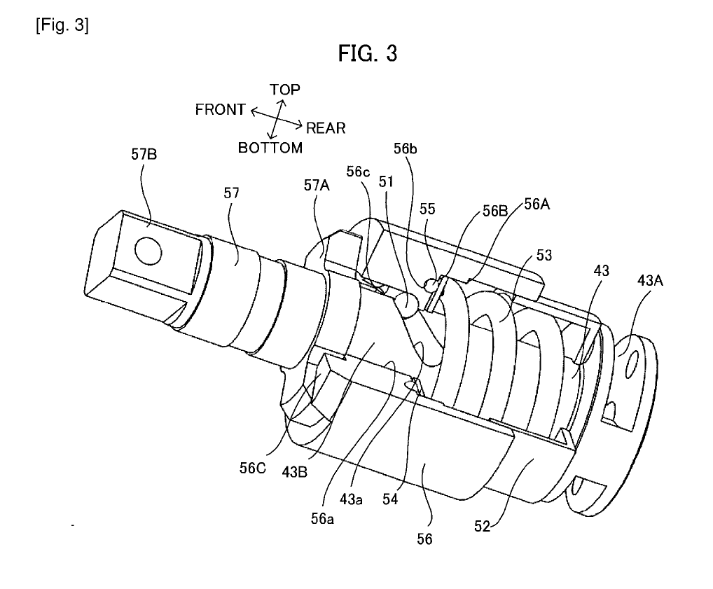

As shown in FIG. 3, the hammer 56 has substantially a hollow cylindrical shape. The hammer 56 is formed with a penetrating hole 56a penetrating the hammer 56 in the front-rear direction and through which the shaft section 43B is inserted. The penetrating hole 56a has a step portion 56A protruding inward in the radial direction, permitting the step portion 56A to contact the front end surface of the stopper 52. A receiving portion 56B is formed at the front side of the step portion 56A. The receiving portion 56B protrudes farther inward in the radial direction than the step portion 56A, and receives the washer 54. The receiving portion 56B is formed with a concave portion 56b depressed in the forward direction. The sphere 55 is rotatably supported by the concave portion 56b, allowing the washer 54 and the spring 53 to rotate relative to the hammer 56.

Two groove portions 56c depressed inward in the radial direction are formed at the front side of the receiving portion 56B. The groove portions 56c are formed at positions confronting respective grooves 43a, so as to support the ball 51 together with the grooves 43a. With this configuration, the hammer 56 is held with respect to the spindle 43, and movement of the ball 51 along the groove 43a enables the hammer 56 to move in the front-rear direction and in the circumferential direction relative to the spindle 43. If the hammer 56 moves rearward more than the predetermined amount, the front end surface of the hammer 56 is brought into a position farther rearward than the grooves 43a, which causes the ball 51 to separate from the grooves 43a. However, a contact between the step portion 56A and the front end surface of the stopper 52 prevents excessive rearward movement of more than the predetermined amount by the hammer 56, which prevents separation of the ball 51. On the front end surface of the hammer 56, two engaging protrusions 56C protruding forward are provided at positions opposing each other with respect to the penetrating hole 56a. The groove portions 56c correspond to a second groove of the present invention.

The anvil 57 has substantially a cylindrical shape, and extends in the front-rear direction. The anvil 57 is provided with two engaged protrusions 57A protruding outward in the radial direction. The anvil 57A has a front end portion provided with a bit mounting section 57B for detachably mounting an end bit (not shown). The two engaged protrusions 57A are provided at positions opposing each other with respect to the rotational axis of the anvil 57.

When the spindle 43 is rotated by the motor 3, the ball 51, the hammer 56, the spring 53, and the stopper 52 rotate together with the spindle 43. This causes the engaging protrusions 56C to engage the engaged protrusions 57A, and the hammer 56 and the anvil 57 rotate together in order to perform a fastening operation of a bolt or the like (rotational mode). As the fastening operation proceeds, the load of the anvil 57 increases. As the load of the motor 3 exceeds, the hammer 56 moves rearward against the urging force of the spring 53. At this time, the ball 51 moves rearward within the groove 43a. When the hammer 56 moves rearward by a distance more than a height of the engaging protrusion 56C in the front-rear direction, the engaging protrusion 56C gets over the engaged protrusion 57A that has engaged the engaging protrusion 56C. Because the rotational force of the spindle 43 is transmitted to the hammer 56 via the ball 51, the hammer 56 continues rotating and each engaging protrusion 56C strikes the engaged protrusion 57A opposite the engaged protrusion 57A that has previously engaged the engaging protrusion 56C (striking mode). This causes the anvil 57 to rotate, and the rotational force is transmitted to the end bit (not shown) as a striking force.

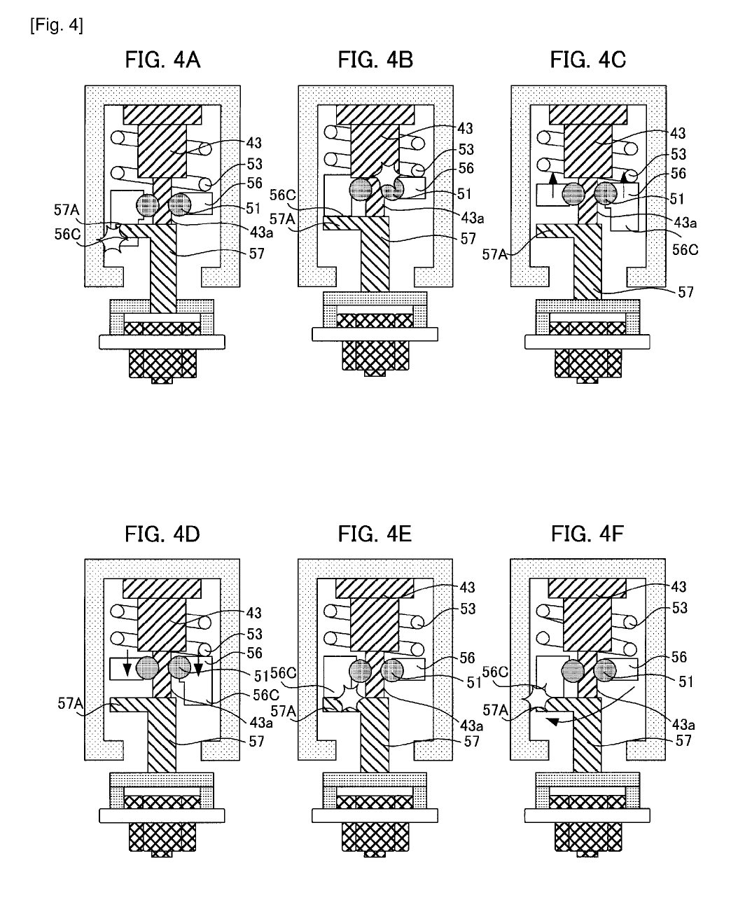

Reaction force is generated when the engaging protrusions 56C strike the engaged protrusions 57A. This reaction force causes the hammer 56 to move rearward against the urging force of the spring 53. At this time, the ball 51 moves rearward along the groove 43a (FIG. 4C). Because the hammer 56 rotates while moving rearward, the engaging protrusion 56C gets over the engaged protrusion 57A struck by the engaging protrusion 56C. The amount of rearward moving of the hammer 56 differs depending on hardness of a workpiece, the shape of the end bit, and the like. After the hammer 56 is arrived at a remote position most separated from the anvil 57 in the axial direction, the urging force of the spring 53 causes the hammer 56 to move forward again (FIG. 4D), and the ball 51 moves forward along the groove 43a. Then, when the ball 51 is located at the foremost position of the groove 43a (FIG. 3), each engaging protrusion 56C strikes the engaged protrusion 57A located at a position opposite the engaged protrusion 57A that has just been struck by the engaging protrusion 56C. A spring constant of the spring 53 and masses, shapes, etc. of the hammer 56 and the anvil 57 are so designed that a portion of the front end surface of the hammer 56 other than the engaging protrusions 56C contacts the rear surfaces of the engaged protrusions 57A and, at the same time, side surfaces of the engaging protrusions 56C in the rotational direction contact side surfaces of the engaged protrusions 57A in the rotational direction. A striking state at this time is referred to as an optimum striking state, which is shown in FIG. 4A. The hammer 56 is positioned at a striking position when the ball 51 is positioned at a frontmost position. Thus, rotational energy of the hammer 56 can be transmitted to the anvil 57 efficiently.

During a fastening operation with the impact wrench 1, the end bit and a fastener such as a bolt sometimes engage and locked with each other, and cannot rotate relative to each other. In this case, because the hammer 56 strikes the anvil 57 while the anvil 57 is in a non-rotatable state, most part of the rotational energy of the hammer 56 returns to the hammer 56 as reaction force, and the hammer 56 moves rearward by a larger amount than in the optimum striking state. With this movement, the ball 51 is brought into contact with the rear end of the groove 43a, and a so-called cam end collision shown in FIG. 4B occurs. Due to the cam end collision, vibrations occurring in the impact wrench 1 increase, and the rotational energy is lost, which leads to a drop in the striking force.

Further striking timings between the hammer 56 and the anvil 57 is deviated, causing phenomena such as a pre-hit and an overshoot. FIG. 4E depicts a state of the pre-hit, and FIG. 4F depicts a state of the overshoot. When the reaction force from the anvil 57 to the hammer 56 is relatively small, the hammer 56 moves forward at earlier timing than in the optimum striking state. And, the front end surface of the engaging protrusion 56C hits the rear surface of the engaged protrusion 57A, that is, a pre-hit occurs. The pre-hit tends to occur under a circumstance in which a load of the end bit promptly decrease on the way of fastening operation or in which the voltage of the commercial power source is unstable. Subsequently, the hammer 56 continues rotating, and the ball 51 is located at the foremost position in the groove 43a. Because the striking timing is deviated, the engaging protrusion 56C and the engaged protrusion 57A to be engaged therewith are spaced away from each other in the rotational direction when the ball 51 is located at the foremost position. Further rotation of the hammer 56 causes the ball 51 to move from one side to the other side each of the V-shaped groove 43a in which the ball 51 is currently reciprocating, which leads to an overshoot. Then, the overshoot causes the hammer 56 to slightly move rearward, and the engaging protrusion 56C strikes the engaged protrusion 57A in a state where the hammer 56 has moved rearward, i.e., the portion of the front end surface of the hammer 56 other than the engaging protrusions 56C is away from the rear surfaces of the engaged protrusions 57A due to the rearward movement of the hammer 56. Hence, the rotational energy of the hammer 56 is not transmitted to the anvil 57 sufficiently. In this way, once the striking timing is deviated, the pre-hit and the overshoot occur successively and the striking force drops. Thus, striking timing should be recovered to the optimum striking state promptly. Note that failures such as the cam end collision, the pre-hit, the overshoot, etc. occur under various conditions as well as the above-described case, depending on the workpiece and the end bit that is used.

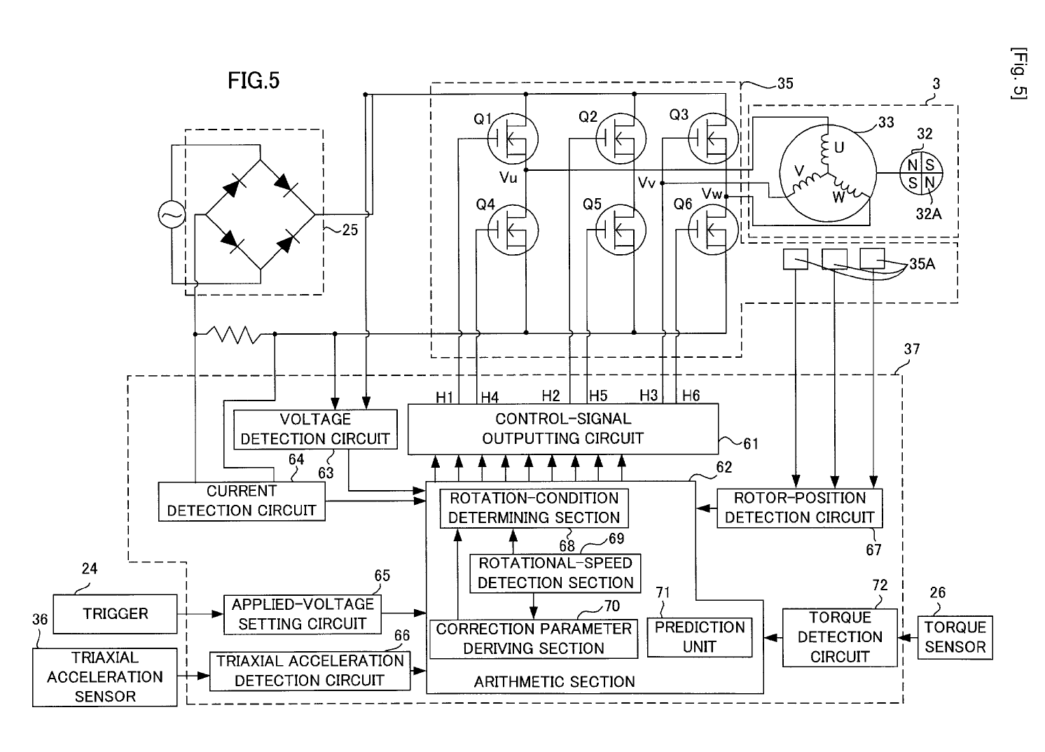

Next, the configuration of a control system for driving the motor 3 will be described while referring to FIG. 5. In the present embodiment, the motor 3 is a three-phase brushless DC motor. The rotor 32 of the brushless DC motor includes the permanent magnet 32A having a plurality of sets (two sets in the present embodiment) of N (north) pole and S (south) pole. The stator 33 includes three-phase stator windings U, V, and W in star connection. A direction and a time period for energizing the stator windings U, V, and W are controlled based on position detection signals from the Hall elements 35A disposed in confrontation with the permanent magnet 32A.

Electrical elements mounted on the board 35 include six switching elements Q1-Q6 such as FET in three-phase bridge connection. Each gate of the six switching elements Q1-Q6 in bridge connection is connected to a control-signal outputting circuit 61. Each drain or each source of the six switching elements Q1-Q6 is connected to the stator windings U, V, and W in star connection. With this configuration, the six switching elements Q1-Q6 perform switching operations with switching-element driving signals (driving signals such as H4, H5, H6 etc.) inputted from the control-signal outputting circuit 61, and converts a DC voltage that is full-wave rectified by the rectifier circuit 25 into three-phase (U-phase, V-phase, and W-phase) voltages Vu, Vv, and Vw, thereby supplying the stator windings U, V, and W with electric power.

Out of switching-element driving signals (three-phase signals), three negative-voltage switching elements Q4, Q5, and Q6 for driving each gate of the six switching elements Q1-Q6 are supplied with pulse-width modulation signals (PWM signals) H4, H5, and H6, respectively. Also, the control circuit 37 is provided with an arithmetic section 62 adapted to change a pulse width of the PWM signal (duty ratio) based on a detection signal of a manipulating amount (stroke) of the trigger 24, thereby adjusting an amount of electric power supplied to the motor 3. In this way, start/stop and the rotational speed of the motor 3 are controlled.

Here, a PWM signal is supplied to either the positive-voltage switching elements Q1-Q3 or the negative-voltage switching elements Q4-Q6 of the board 35. By switching the switching elements Q1-Q3 or the switching elements Q4-Q6 at high speed, electric power supplied from DC voltage of the rectifier circuit 25 to each of the stator windings U, V, and W is controlled. Note that, because the PWM signal is supplied to the negative-voltage switching elements Q4-Q6, by controlling the pulse width of the PWM signal, electric power supplied to each of the stator windings U, V, and W is adjusted so as to control the rotational speed of the motor 3.

The control circuit 37 includes the control-signal outputting circuit 61, the arithmetic section 62, a voltage detection circuit 63, a current detection circuit 64, an applied-voltage setting circuit 65, a triaxial acceleration detection circuit 66, a rotor-position detection circuit 67, and a torque detection circuit 72. The arithmetic section 62 includes a rotation-condition determining section 68, a rotational speed detection unit 69, a correction-parameter deriving section 70, a prediction unit 71, a central processing unit (CPU) for outputting driving signals based on processing programs and data, a ROM for storing the processing programs and control data, and a RAM for temporarily storing data and threshold values described later (these are not shown). The control circuit 37 and the arithmetic section 62 correspond to a controller of the present invention.

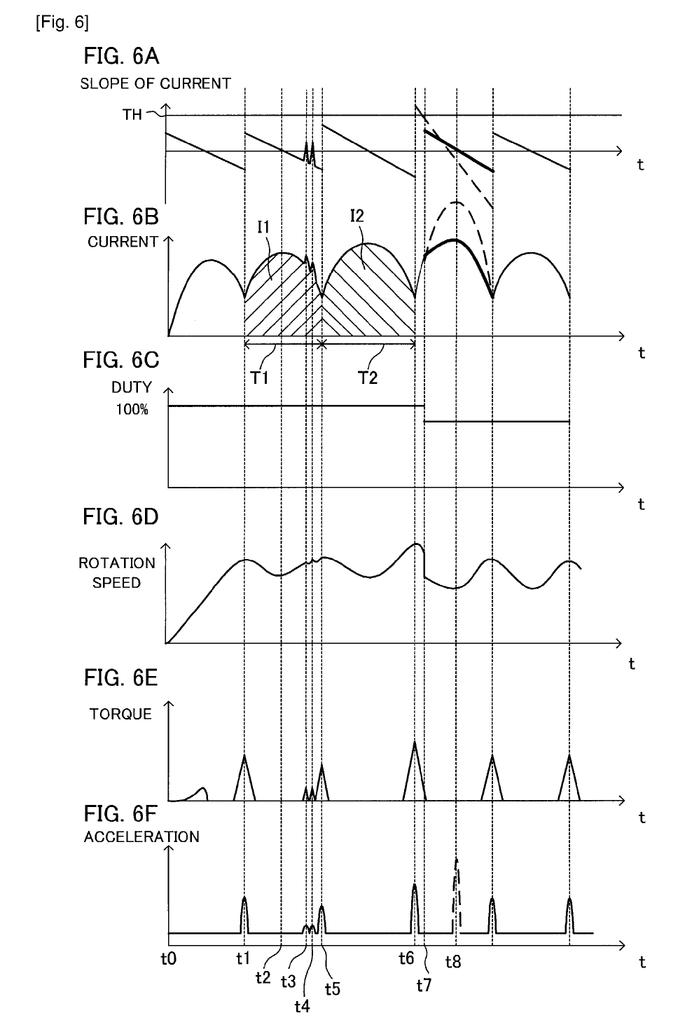

The arithmetic section 62 generates driving signals for alternately switching predetermined switching elements Q1-Q6 based on the output signal from the rotor-position detection circuit 67, and outputs the control signals to the control-signal outputting circuit 61. With this operation, predetermined windings of the stator windings U, V, and W are alternately energized to rotate the rotor 32 in a set rotational direction. In this case, the driving signals applied to the negative-voltage switching elements Q4-Q6 are outputted as PWM modulation signals based on output control signals of the applied-voltage setting circuit 65. The voltage detection circuit 63 and the current detection circuit 64 detect a voltage value and a current value, respectively, that are supplied to the motor 3, and these values are fed back to the arithmetic section 62, thereby adjusting the voltage value and the current value so that the set driving power and current are obtained. FIG. 6B shows detection results of the current detection circuit 64. Note that the PWM signals may be applied to the positive-voltage switching elements Q1-Q3. The current detection circuit 64 is one example of the load detection unit.

The applied-voltage setting circuit 65 outputs control signals to the arithmetic section 62 based on an operation amount of the trigger 24. The triaxial acceleration detection circuit 66 outputs each acceleration value in the thrust direction and in the rotational direction to the arithmetic section 62, based on signals from the triaxial acceleration sensor 36. The torque detection circuit 72 is adapted to output fastening torque to the arithmetic section 62 based on a signal from a torque sensor 26 for detecting the fastening torque of the end bit.

The rotation-condition determining section 68 determines whether striking between the hammer 56 and the anvil 57 is in the optimum striking state, based on the output signals from at least one of the current detection circuit 64, the triaxial acceleration detection circuit 66, the rotational-speed detection section 69, the torque detection section circuit 72, and the prediction unit 71. FIG. 6D shows detection results of the rotational speed detection unit 69. The rotational speed detection unit 69 detects the rotational speed of the motor 3 based on the signals from the rotor-position detection circuit 67. The correction-parameter deriving section 70 derives a correction parameter for adjusting the PWM duty for controlling the motor 3, based on the determination result of the rotation-condition determining section 68. The prediction unit 71 predicts the slope of the current (rate of change of the current) detected by the current detection circuit 64 as shown in FIG. 6A, and the slope of the rotational speed (rate of change of the rotational speed) of the motor 3.

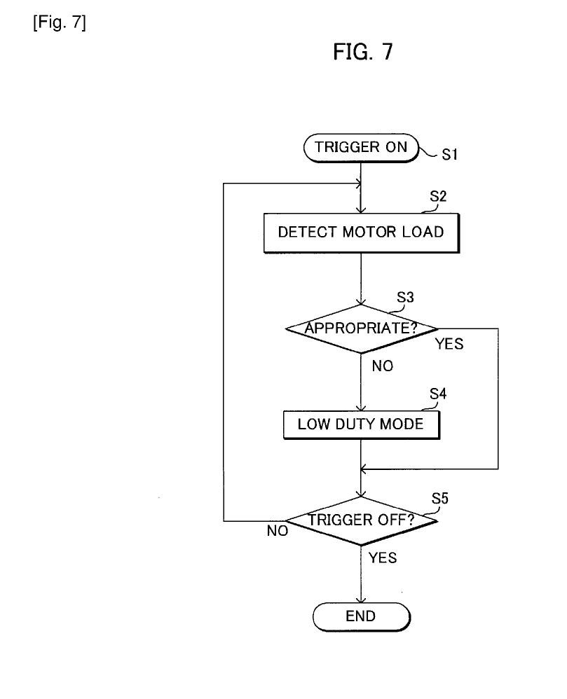

Next, the operations of the impact wrench 1 will be described while referring to FIGS. 6A-6F through 7.

After the power cable 23 is connected to a commercial power source, not shown, and the trigger 24 is pulled, the motor 3 starts to operate (t0 in FIG. 6), and the flowchart of FIG. 7 therefore starts (S1 in FIG. 7). Specifically, the current detection circuit 64 detects current supplied to the motor 3 as a motor load. In the case of the present embodiment, the current is detected as one example of a motor load. At the beginning of the fastening operation, the load imposed on the end bit (anvil 57) is relatively small; the hammer 56 and the anvil 57 therefore rotate together. As the load imposed on the end bit (anvil 57) becomes larger, the hammer 56 moves backward against the urging force of the spring 53, and then the hammer 56 starts striking the anvil 57 (t1 in FIGS. 6A-6F). Accordingly, the impact wrench 1 shifts into the striking mode from the rotational mode. When a first strike occurs at time t1, as shown in FIG. 6B, the current detected by the current detection circuit 64 decreases to a minimum value at the timing of striking More specifically, the current turns to increase upon the striking. As shown in FIG. 6D, the rotational speed continuously increases from time t0 and then turns to decrease upon the striking at the time t1. As shown in FIGS. 6E and 6F, the fastening torque and the acceleration peak at time t1. After the striking, the hammer 56 moves backward along the grooves 43a of the spindle 43. At this time, the spindle 43 and the hammer 56 rotate relatively to each other, and the load of the motor 3 therefore increases. As a result, the current shown in FIG. 6B increases, and the rotational speed shown in FIG. 6D decreases. At time t2, the hammer 56 is at the remote position, and the slope of the current is zero as shown in FIG. 6A. Accordingly, the slope of the rotational speed shown in FIG. 6D is also zero. At this time, the cam-end collision has not occurred. Therefore, the ball 51 is away from the rear end of the groove 43a. After time t2, the hammer 56 moves forward along the groove 43a due to the urging force of the spring 53. At this time, the hammer 56 moves forward while being rotated in the same direction as the rotation direction of the spindle 43. Therefore, the load on the motor 3 decreases. As a result, the current shown in FIG. 6B decreases, and the rotational speed shown in FIG. 6D increases.

At time t3 shown in FIGS. 6A-6F, the pre-hit occurs, and the current and the rotational speed are temporarily pulsating, and a fastening torque is slightly generated. Due to the occurrence of the pre-hit, the striking timing is deviated, and subsequent overshoot occurs at time t4. Then, similarly, the current and the rotational speed are temporarily pulsating, and a fastening torque is slightly generated.

At time t5 shown in FIG. 6, the hammer 56 strikes the anvil 57 again. The fastening torque generated at time t5 is smaller than that of at time t1 because the pre-hit at time t3 and the overshoot at time t4 consume rotational energy. At this time, the slope of the current shown in FIG. 6A is less than a current threshold value, and the arithmetic section 62 determines that the calculation value therefore is appropriate (S3: YES). The current threshold value is preliminarily stored in the RAM. The arithmetic section 62 37 determines whether the strike between the hammer 56 and the anvil 57 is the optimum striking state based on the current threshold value, i.e., the arithmetic section 62 determines that the strike is the optimum striking state when the slope of the current is less than the current threshold value. When the hammer 56 strikes the anvil 57 again at t6, the current begins to increase after decreasing, and then the slope of the current shown in FIG. 6A exceeds the current threshold value (S3: NO). Then, because the hammer 56 receives a relatively large reaction force from the anvil 57 at the time of the striking at time t6, the hammer 56 rapidly moves backward, resulting in a rapid increase in the load on the motor 3. In this state, the cam-end collision may be occurred as indicated by imaginary dotted line of FIGS. 6A and 6B as the hammer 56 rapidly moves backward. On the imaginary dotted line, the cam-end collision occurs at time t8 when the hammer 56 reaches the remote position. FIG. 6F shows vibration caused by the cam-end collision at time t8 as indicated by imaginary dotted line. However, according to the present invention, at time t6, the prediction unit 71 calculates a duty ratio that provides the optimum striking state as indicated by bold line of FIG. 6B. The arithmetic section 62 reduces the duty ratio at time t7 for the impact wrench 1 to shift into a low duty mode (S4), as shown in FIG. 6C. That is, after the load on the motor 3 begins to increase at time t6 and before the hammer 56 reaches the remote position (i.e. before being at a peak after time t6), the impact wrench 1 shifts into the low duty mode. In the present invention, a time “after the load begins to increase and before the load turns to decrease” corresponds to a time after time t6 and before time t8 in FIG. 6B. The period between time t6 and time t7 is a delay time that the prediction unit 71 uses to calculate the duty ratio.

Since the impact wrench 1 shifts into the low duty mode at time t7, the slope of the current shown in FIG. 6A decreases sharply as indicated by bold line, and the current of FIG. 6B also ends up being in the optimum striking state as indicated by bold line. Moreover, the rotational speed as shown in FIG. 6D declines as the duty ratio decreases. When the subsequent strike occurs, the calculation value becomes appropriate because the slope of the current does not exceed the current threshold value (S3: YES), and the duty ratio remains unchanged (FIG. 6C). Although not shown in FIGS. 6A-6F, if the slope of the current exceeds the current threshold value after still another strike occurs, the arithmetic section 62 determines that the calculation value is not appropriate (S3: NO), and the prediction unit 71 calculates and decreases the duty ratio again. Until the trigger 24 is turned OFF, the processes S2 to S4 are repeatedly performed (S5: NO). The fastening operation comes to an end after the trigger 24 is turned OFF (S5: YES). As a result, the low duty mode that has been set in S4 is canceled. Therefore, the duty ratio will be 100% when the trigger 24 is turned ON again.

According to the present embodiment, after the impact wrench 1 shifts into the low duty mode, the low duty mode continues. However, after a predetermined period of time has passed, the duty ratio may be reset at 100%. For example, the low duty mode is preferred in a situation where the end bit and the stopper are temporarily in a locking state, because the cam-end collision may occur. However, once this lock is released, there is a low possibility of the occurrence of the cam-end collision. Therefore, reset of the duty ratio at 100% provides efficient fastening operation.

In the above configuration, the arithmetic section 62 reduces the duty ratio of the drive power of the motor 3 after the hammer 56 strikes the anvil 57 and the current then begins to increase, and before the current turns to decrease. Therefore, the occurrence of the cam-end collision itself can be prevented in comparison with a case where the duty ratio of the motor decreases after the cam-end collision occurs, a current increases (dotted line of FIG. 6B), and an increase in the current is detected. As a result, this configuration prevents the vibrations and energy losses occurring upon the cam-end collision in the impact wrench 1.

According to the above configuration, when the rate of change of the current calculated by the prediction unit 71 based on the current detected by the current detection circuit 64 exceeds the current threshold value, the impact wrench 1 shifts into the low duty mode. Therefore, because the rate of change of the current becomes larger, the possibility of the occurrence of the cam-end collision can be predicted. Then, the impact wrench 1 shifts into the low duty mode, thereby preventing the occurrence of the cam-end collision. Thus, this configuration prevents the vibrations and energy losses upon the cam-end collision in the impact wrench 1.

According to the above configuration, since the arithmetic section 62 reduces the duty ratio before the hammer 56 reaches the remote position most separated from the anvil 57, a rotational force transmitted to the hammer 56 is reduced before the hammer 56 reaches the remote position. Thus, the occurrence of the cam-end collision generated upon the arrival of the hammer 56 at the remote position can be prevented.

A first modification of the first embodiment of the present invention will be described with reference to FIG. 6D. In the above embodiment, the current detection circuit 64 is used as one example of a load detection unit. In the first modification, the rotational speed detection unit 69 is used as a load detection unit.

The prediction unit 71 calculates the slope of the rotational speed (rate of change of the rotational speed). In the RAM of the arithmetic section 62, a rotational speed threshold value for the slope of the rotational speed is stored. In the flowchart of FIG. 7, the rotational speed detection unit 69 detects the rotational speed of the motor 3 as a motor load at S2. At time t6, when the hammer 56 receives large reaction force from the anvil 57, the load on the motor 3 rapidly becomes larger, and therefore the slope of the rotational speed sharply decreases immediately after time t6, as shown in FIG. 6D. After the slope of the rotational speed becomes less than the rotational speed threshold value stored in the RAM, the arithmetic section 62 determines that the calculation value is not appropriate (S3: NO), and then the impact wrench 1 shifts into the low duty mode at time t7 (S4). That is, the impact wrench 1 shifts into the low duty mode after the rotational speed turns from an increase to a decrease (time t6) and before the rotational speed turns from the decrease to the increase (time t8).

According to the above configuration, since the arithmetic section 62 reduces the duty ratio of the drive power of the motor 3, i.e., the impact wrench 1 shifts into the low duty mode, based on the rotational speed of the motor 3 before the cam-end collision occurs, the occurrence of the cam-end collision can be prevented. As a result, this configuration prevents the vibrations and energy losses occurring upon the cam-end collision in the impact wrench 1.

A second modification of the first embodiment of the present invention will be described with reference to FIG. 6E. In the second modification, the torque detection circuit 72 is used as a load detection unit.

The prediction unit 71 calculates the slope of the fastening torque shown in FIG. 6E. In the RAM of the arithmetic section 62, a torque threshold value for the slope of the fastening torque is preliminarily stored. In the flowchart of FIG. 7, the torque detection circuit 72 detects the fastening torque as a motor load at S2. At time t6, the hammer 56 receives large reaction force from the anvil 57, as in the case of the slope of the current, the slope of the fastening torque rapidly becomes larger immediately after time t6. After the slope of the fastening torque exceeds the torque threshold value, the arithmetic section 62 determines that the calculation value is not appropriate (S3: NO), and then the impact wrench 1 shifts into the low duty mode at time t7 (S4). That is, the impact wrench 1 shifts into the low duty mode after the fastening torque reaches a peak at time t6 and before the hammer reaches the remote position (time t8).

According to the above configuration, since the arithmetic section 62 reduces the duty ratio of the drive power of the motor 3, i.e., the impact wrench 1 shifts into the low duty mode, based on the fastening torque before the cam-end collision occurs, the occurrence of the cam-end collision can be prevented. As a result, this configuration prevents the vibrations and energy losses occurring upon the cam-end collision in the impact wrench 1.

In the above configuration, after the rotational speed turns from the increase to the decrease, and before the rotational speed turns from the decrease to the increase, the arithmetic section 62 reduces the duty ratio of the drive power of the motor 3. Therefore, the occurrence of the cam-end collision itself can be prevented in comparison with a case where the duty ratio of the motor decreases after the cam-end collision occurs, a current increases (dotted line of FIG. 6B), and a decrease of the rotational speed is detected. As a result, this configuration prevents the vibrations and energy losses occurring upon the cam-end collision in the impact wrench 1.

A third modification of the first embodiment of the present invention will be described with reference to FIG. 6F. In the third modification, the triaxial acceleration detection circuit 66 is used as a load detection unit. The triaxial acceleration detection circuit 66 detects acceleration in three-axis directions, thereby detecting vibrations occurring in the impact wrench 1.

The prediction unit 71 calculates the slope of the acceleration (rate of change of the acceleration) shown in FIG. 6F. In the RAM of the arithmetic section 62, a vibration threshold value for the slope of the acceleration is preliminarily stored. In the flowchart of FIG. 7, the triaxial acceleration detection circuit 66 detects the acceleration generated in the impact wrench 1 as a vibration at S2. At time t6, the hammer 56 receives large reaction force from the anvil 57, the vibration occurring in the impact wrench 1 becomes larger, and thus the slope of the acceleration becomes larger. In this case, the hammer 56 is expected to rapidly move backward, causing the cam-end collision. After the slope of the acceleration exceeds the vibration threshold value, the arithmetic section 62 determines that the calculation value is not appropriate (S3: NO), and then the impact wrench 1 shifts into the low duty mode at time t7 (S4).

According to the above configuration, if the slope of the acceleration exceeds the vibration threshold value, i.e., the vibration becomes larger, the arithmetic section 62 determines that the cam-end collision may occur and the impact wrench 1 shifts into the low-duty mode, thereby preventing the occurrence of the cam-end collision. As a result, this configuration prevents the vibrations and energy losses occurring upon the cam-end collision in the impact wrench 1.

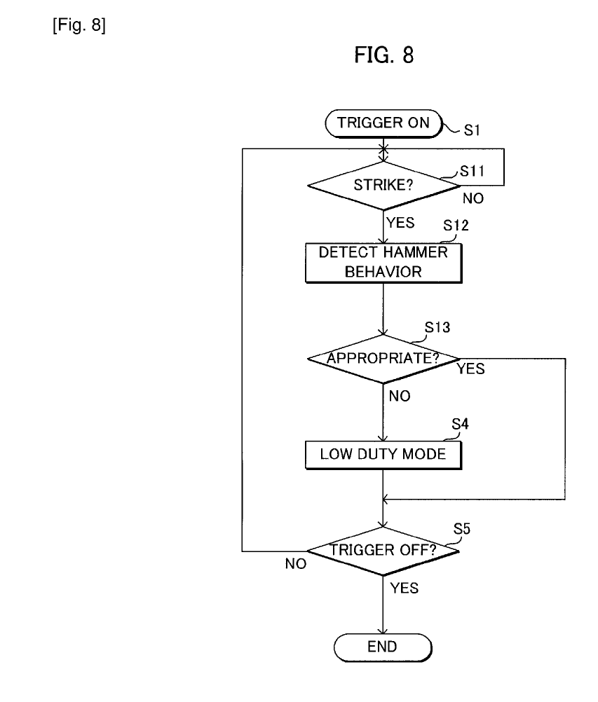

A fourth modification of the first embodiment of the present invention will be described with reference to FIGS. 6B and 8. In the following description, like parts and components to those in the above embodiment and modifications have been designated with the same reference numerals to avoid duplicating description. In the fourth modification, the impact wrench 1 shifts into the low duty mode depending on the behavior of the hammer 56 between the strike actions. More specifically, the occurrence of the cam-end collision is predicted by calculating a cycle of the striking.

In the RAM of the arithmetic section 62, a cycle threshold value for the cycle of the striking is preliminarily stored. The prediction unit 71 calculates the cycle of the striking based on the current shown in FIG. 6B. That is, the prediction unit 71 calculates a cycle of the previous striking at the timing of current striking More specifically, when the second striking is occurred at time t5 (S11: YES), the arithmetic section 62 detects the behavior of the hammer 56 (S12). That is, the prediction unit 71 calculates a cycle T1 from time t1 to time t5 (S12), and compares the cycle T1 with the cycle threshold value to make a determination whether or not the calculation value is appropriate (S13). The prediction unit 71 repeatedly executes S12 to S5 for each striking, and compares the calculated cycle with the cycle threshold value. Upon the third striking at time t6 (S11: YES), the prediction unit 71 calculates a cycle T2 from time t5 to time t6, and then compares the cycle T2 with the cycle threshold value (S13). The cycle T2 calculated at time t6 is longer than the cycle T1 calculated at time t5. This is because the backward movement amount of the hammer 56 has increased. If the hammer 56 moves forward and strikes the anvil 57 in this state, the reaction force that the hammer 56 receives from the anvil 57 becomes larger, possibly causing the cam-end collision. Therefore, when the cycle T2 is greater than the cycle threshold value, the arithmetic section 62 determines that the calculation value is not appropriate (S13: NO), and then the impact wrench 1 shifts into the low duty mode at time t7 (S4).

According to the above configuration, since the occurrence of the cam-end collision is predicted based on the behavior of the hammer 56 and the impact wrench 1 shifts into the low duty mode, the occurrence of the cam-end collision can be prevented. As a result, this configuration prevents the vibrations and energy losses occurring upon the cam-end collision in the impact wrench 1.

According to the above configuration, if the cycle exceeds the cycle threshold value, the arithmetic section 62 determines that the cam-end collision may occur and the impact wrench 1 shifts into the low-duty mode, thereby preventing the occurrence of the cam-end collision. As a result, this configuration prevents the vibrations and energy losses occurring upon the cam-end collision in the impact wrench 1.

A fifth modification of the first embodiment of the present invention will be described with reference to FIGS. 6B and 8. In the fifth modification, the impact wrench 1 shifts into the low duty mode depending on the behavior of the hammer 56 between the strike actions. More specifically, the occurrence of the cam-end collision is predicted by calculating an integral value of the current between the strike actions.

In the RAM of the arithmetic section 62, an integral threshold value for the integral value of the current is preliminarily stored. When the second striking occurs at time t5 (S11: YES), the prediction unit 71 calculates an integral value I1 of the current for the cycle T1 from time t1 to time t5 (S12). The prediction unit 71 compares the calculated integral value of current with the integral threshold value to make a determination as to whether or not the calculation value is appropriate (S13). The prediction unit 71 repeatedly executes S12 to S5 for each strike action, and compares the calculated value of integral with the integral threshold value. When the third striking occurs at time t6 (S11: YES), the prediction unit 71 calculates an integral value 12 for the cycle T2 from time t5 to time t6 and compares the calculated integral value 12 with the integral threshold value (S13). As shown in FIG. 6B, the integral value 12 calculated at time t6 is greater than the integral value I1 calculated at time t5. This is because the backward movement amount of the hammer 56 has increased. If the hammer 56 moves forward and strikes the anvil 57 in this state, the reaction force that the hammer 56 receives from the anvil 57 becomes larger, possibly causing the cam-end collision. Therefore, when the integral value 12 of current is greater than the integral threshold value, the arithmetic section 62 determines that the calculation value is not appropriate (S13: NO), and then the impact wrench 1 shifts into the low duty mode at time t7 (S4). In the fifth modification, in addition to the time represented in abscissa axis of FIG. 6B, an increase in the current value represented in ordinate axis of FIG. 6B can also be calculated. Compared with the fourth modification in which only the time is detected, the fifth modification can enhance the accuracy of predicting the occurrence of the cam-end collision.

According to the above configuration, if the integral value of the current exceeds the integral threshold value, the arithmetic section 62 determines that the cam-end collision may occur and the impact wrench 1 shifts into the low-duty mode, thereby preventing the occurrence of the cam-end collision. As a result, this configuration prevents the vibrations and energy losses occurring upon the cam-end collision in the impact wrench 1.

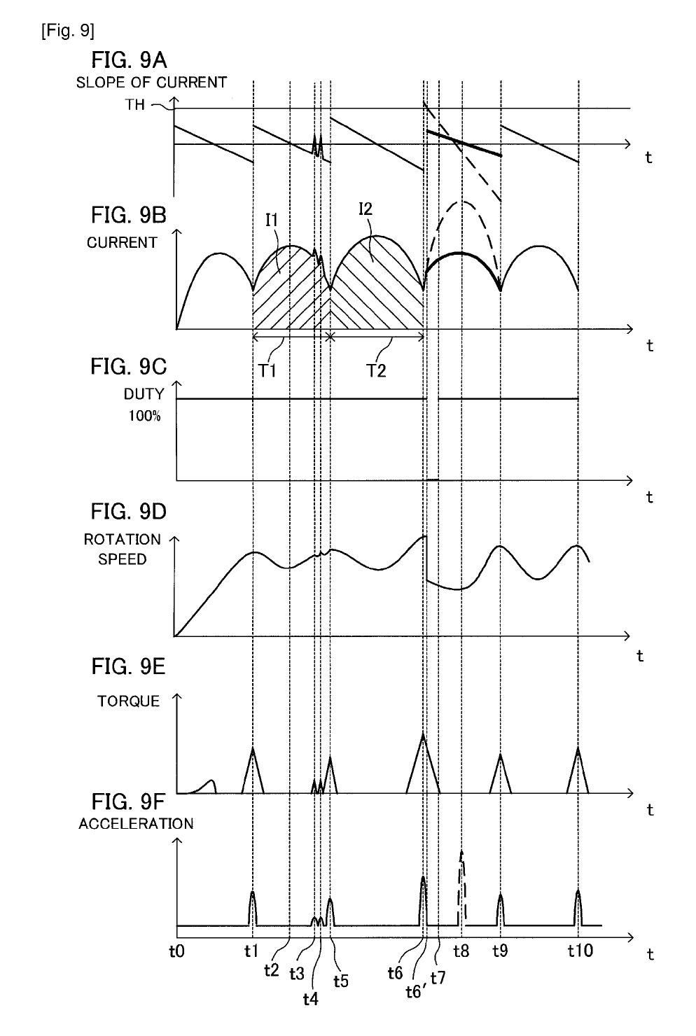

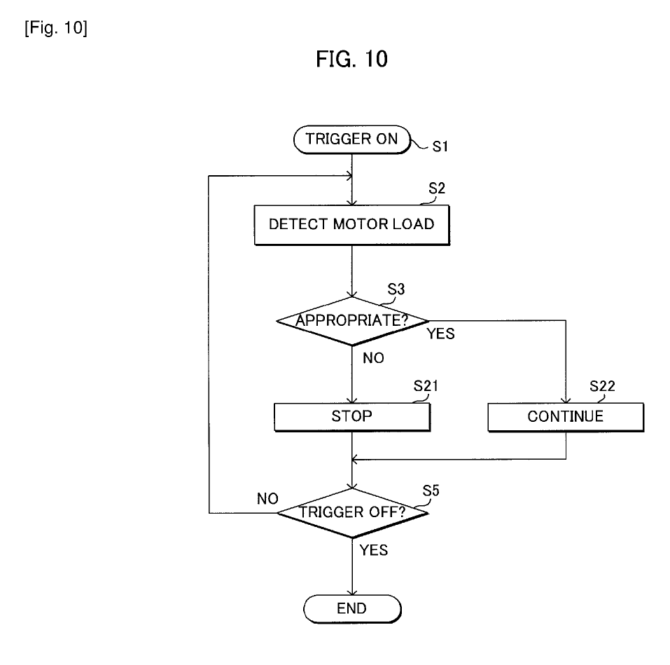

A second embodiment of the present invention will be described based on FIGS. 9 and 10. The same components as those of the first embodiment and its modifications are represented by the same reference symbols, and will not be described again to avoid duplicating description.

As shown in FIG. 9A, when the slope of the current shown in FIG. 9A exceeds the current threshold value immediately after time t6, the arithmetic section 62 determines that the calculation value is not appropriate (S3 in FIG. 10: NO), and a brake is put on the motor 3 at time t6′. More specifically, as shown in FIG. 9C, the duty ratio is set to zero during a period t msec (from time t6′ to time t7). Since the current flowing to the motor 3 is temporarily interrupted at time t6′, the slope of the current of FIG. 9A decreases as indicated by bold line, and the current of FIG. 9B also decreases in a state indicated by bold line in comparison with the dotted line. Moreover, the rotational speed shown in FIG. 9D drops as the motor 3 is temporarily stopped. Therefore, the occurrence of the cam-end collision can be prevented. Because the motor 3 is temporarily stopped, as shown in FIG. 9E, the fastening torque is lowered at time t9. However, in the subsequent striking at time t10, the fastening torque is in the optimum striking state.

Incidentally, in the second embodiment, similarly to the modifications of the first embodiment, the other values as the calculation value at S3 may be employed instead of the slope of the current. Specifically, the slope of the rotational speed shown in FIG. 9D, the slope of the torque shown in FIG. 9E, the slope of the acceleration shown in FIG. 9F, the period between strike actions, and the value of integral of the current can be employed.

According to the above configuration, the delay time is shorter compared with the first embodiment because the prediction unit 71 does not need to calculate the duty ratio. That is, the delay time between time t6 and time t6′ in the second embodiment is shorter than the delay time between time t6 and time t7 in the first embodiment. Thus, even if the striking intervals are short, the occurrence of the cam-end collision can be reliably prevented.

A modification of the second embodiment of the present invention will be described.

In the second embodiment, the duty ratio is temporarily set to zero so as to stop the motor 3. In the modification, the arithmetic section 62 controls the motor 3 to aggressively rotate the motor 3 in reverse. The period during which the arithmetic section 62 controls the motor 3 to rotate the motor 3 in reverse is shorter than the period t msec when the motor 3 is stopped in the second embodiment. As a result, the delay time becomes even shorter than in the second embodiment, reliably preventing the cam-end collision.

While the invention has been described in detail with reference to the embodiments thereof, it would be apparent to those skilled in the art that various changes and modifications may be made therein without departing from the spirit of the invention.

In the above embodiments and modifications, at least two following values as the calculation value at S3 are employed instead of the slope of the current: the slope of the rotational speed shown in FIG. 6D or 9D; the slope of the torque shown in FIG. 6E or 9E; the slope of the acceleration shown in FIG. 6F or 9F; the period between strike actions; and the value of integral of the current, thereby enhancing the accuracy of predicting the occurrence of the cam-end collision.

In the above embodiments, the impact wrench is used as one example of the power tool. Instead of the impact wrench, an impact driver may be used. The period between strike actions of the impact wrench is about 30 msec while the period between strike actions of the impact driver is 15 to 20 msec. Accordingly, if the present invention is applied to the impact driver, the second embodiment is preferably applied because the delay time would be affected extremely. Even if the first embodiment is applied to the impact driver, the advantageous effects of the present invention can be achieved.

In the above embodiments, as the motor 3, an electric motor is used. Instead, an air motor may be used.

### REFERENCE SIGNS LIST

1 Impact wrench
2 Housing
3 Motor
4 Gear mechanism
5 Impact mechanism
24 Trigger
25 Rectifier circuit
26 Torque sensor
31 Output shaft
36 Triaxial acceleration sensor
37 Control circuit
43a Groove
51 Ball
56 Hammer
56c Groove
57 Anvil
62 Arithmetic section
66 Triaxial acceleration detection circuit
67 Rotor-position detection circuit
68 Rotation-condition determining section
69 Rotational-speed detection section
70 Correction-parameter deriving section
72 Torque detection circuit

1. A power tool comprising:
a housing;
a motor accommodated in the housing;
a hammer configured to be rotated by the motor;
an anvil configured to be rotated in one of a rotational mode in which the anvil is rotated together with the hammer and a striking mode in which the anvil is rotated upon being struck by the hammer; and
a controller configured to control the motor to be braked in the striking mode.

2. The power tool according to claim 1, further comprising a power supply unit configured to supply drive power to the motor,
wherein the controller is configured to control the power supply unit to temporarily set a duty ratio of the drive power to zero in the striking mode.

3. The power tool according to claim 1, wherein the controller is configured to control the motor to rotate in reverse in the striking mode.

4. The power tool according to claim 1, wherein the hammer is configured to be movable between a strike position where the hammer strikes the anvil and a remote position where the hammer is separated from the anvil in an axial direction of the motor, wherein the controller is configured to control the motor to be braked after the hammer strikes the anvil and before the hammer reaches the remote position.

5. A power tool comprising:
a housing;
a motor accommodated in the housing;
a power supply unit configured to supply drive power to the motor;
a hammer configured to be rotated by the motor;
an anvil configured to be rotated upon being struck by the hammer;
a load detection unit configured to detect a load of the motor; and
a controller configured to control the power supply unit to decrease a duty ratio of the drive power supplied to the motor after the load begins to increase and before the load turns to decrease.

6. The power tool according to claim 5, wherein the load detection unit is configured to detect a fastening torque of the anvil,
wherein the controller controls the power supply unit to decrease the duty ratio of the drive power after the fastening torque reaches a peak upon the striking of the hammer to the anvil.

7. The power tool according to claim 6, wherein the motor has an output shaft extending an axial direction,
wherein the hammer is configured to be movable between a strike position where the hammer strikes the anvil and a remote position where the hammer is separated from the anvil in the axial direction,
wherein the controller controls the power supply unit to decrease the duty ratio of the drive power after the fastening torque reaches the peak and before the hammer reaches the remote position.

8. The power tool according to claim 5, wherein the load detection unit is configured to detect a current of the motor,
wherein the controller controls the power supply unit to decrease the duty ratio of the drive power after the current of the motor turns from a decrease to an increase.

9. The power tool according to claim 8, wherein the controller controls the power supply unit to decrease the duty ratio of the drive power after the current of the motor turns from a decrease to an increase and before the current of the motor begins to decrease.

10. The power tool according to claim 5, wherein the load detection unit is configured to detect a rotational speed of the motor,
wherein the controller controls the power supply unit to decrease the duty ratio of the drive power after the rotational speed turns from an increase to a decrease.

11. The power tool according to claim 10, wherein the controller controls the power supply unit to decrease the duty ratio of the drive power after the rotational speed turns from the increase to the decrease and before the rotational speed turns from the decrease to the increase.

12. A power tool comprising:
a housing;
a motor accommodated in the housing;
a power supply unit configured to supply drive power to the motor;
a hammer configured to be rotated by the motor;
an anvil configured to be rotated upon being struck by the hammer;
a load detection unit configured to detect a load of the motor; and
a controller configured to control the power supply unit to change to a low duty mode in which a duty ratio of the drive power supplied to the motor decreases when a rate of change of the load of the motor exceeds a predetermined threshold value.

13. The power tool according to claim 12, wherein the load detection unit is configured to detect a fastening torque of the anvil,
wherein the controller controls the power supply unit to change to the low duty mode when a rate of change of the fastening torque exceeds a torque threshold value.

14. The power tool according to claim 12, wherein the load detection unit is configured to detect a current of the motor,
wherein the controller controls the power supply unit to change to the low duty mode when a rate of change of the current exceeds a current threshold value.

15. The power tool according to claim 12, wherein the load detection unit is configured to detect a rotational speed of the motor,
wherein the controller controls the power supply unit to change to the low duty mode when a rate of change of the rotational speed exceeds a rotational speed threshold value.

16. A power tool comprising:
a housing;
a motor accommodated in the housing;
a power supply unit configured to supply drive power to the motor;
a hammer configured to be rotated by the motor;
an anvil configured to be rotated upon being struck by the hammer; and
a controller configured to control the power supply unit to change, based on a behavior of the hammer during a period from a striking between the hammer and the anvil to a subsequent striking therebetween, to a low duty mode in which a duty ratio of the drive power supplied to the motor decreases.

17. The power tool according to claim 16, wherein the controller controls the power supply unit to change to the low duty mode when the period exceeds a cycle threshold value.

18. The power tool according to claim 16, further comprising a load detection unit configured to detect a current of the motor,
wherein the controller controls the power supply unit to change to the low duty mode when an integral of the current from the striking to the subsequent striking exceeds an integral threshold value.

19. A power tool comprising:
a housing;
a motor accommodated in the housing;
a power supply unit configured to supply drive power to the motor;
a hammer configured to be rotated by the motor;
an anvil configured to be rotated upon being struck by the hammer;
a vibration detection unit configured to detect a vibration generated upon a striking between the hammer and the anvil; and
a controller configured to control the power supply unit to decrease a duty ratio of the drive power supplied to the motor when the vibration detected by the vibration detection unit exceeds a vibration threshold value.

20. A power tool comprising:
a housing;
a motor accommodated in the housing and having an output shaft extending in an axial direction;
a power supply unit configured to supply drive power to the motor;
a spindle configured to be rotated by the motor and formed with a first groove extending in a direction intersecting the axial direction, the first groove having one end portion at the motor side and another end portion opposed to the one end portion in the axial direction;
an engaging member having an accommodated part accommodated in the first groove and a remaining part;
a hammer configured to be supplied with a rotation from the spindle through the engaging member, the hammer being configured to be movable in the axial direction and formed with a second groove for accommodating the remaining part of the engaging member;
an urging member configured to urge the hammer in the axial direction;
an anvil configured to be rotated upon being struck by the hammer; and
a controller configured to control the power supply unit to decrease a duty ratio of the drive power supplied to the motor before a cam-end collision occurs in which the engaging member contacts the one end portion of the first groove.
